(19) United States
(12) Patent Application Publication
(10) Pub. No.: US 2013/0186810 A1
(43) Pub. Date: Jul. 25, 2013

(54) System and Method for Processing Alternate Fuel Sources

(71) Applicants: Thomas A. Volini, Oak Brook, IL (US); John J. Sudnick, Greer, SC (US); Bart T. Lynam, Edmonds, WA (US)

(72) Inventors: Thomas A. Volini, Oak Brook, IL (US); John J. Sudnick, Greer, SC (US); Bart T. Lynam, Edmonds, WA (US)

(21) Appl. No.: 13/544,845

(22) Filed: Jul. 9, 2012

Related U.S. Application Data
(60) Provisional application No. 61/505,950, filed on Jul. 8, 2011.

(51) Int. Cl. C02F 3/28

(52) U.S. Cl. CPC C02F 3/28
USPC 210/150

(57) ABSTRACT

An energy conserving wastewater treatment system capable of being fueled by alternate fuel sources comprises a synthesis gas generator that produces synthesis gas from a fuel and an organic waste digester that produces biogas. A combined synthesis gas and biogas storage reservoir that is in communication with both the synthesis gas generator and the organic waste digester. At least one boiler is in communication with the combined synthesis gas and biogas storage reservoir.

### CROSS REFERENCE TO RELATED APPLICATIONS

This application claims the benefit of U.S. Provisional Patent Application Ser. No. 61/505,950, filed on Jul. 8, 2011.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present disclosure relates to a method and system of processing alternative fuel sources in the treatment of waste water, and more particularly, to a system having a gasifier, a gas cleaning and conditioning system, and a combustion system that utilizes synthesis gas and biogas to produce energy in an effort to improve the waste water treatment process.

2. Description of the Background of the Invention

Energy is typically provided to wastewater treatment plants and other industrial plants utilizing conventional forms of electrical power. Costs to operate a plant and the associated equipment are typically large. Further, numerous secondary or waste streams that are both toxic and non-toxic are typically emitted from the plant in solid, liquid, or gaseous form that must be treated and disposed of according to government regulations. Therefore, it is desirable to find ways to utilize and recycle the secondary streams in cost-effective and environmentally friendly manners.

One system and method disclosed herein combines a quantity of synthesis gas with a quantity of biogas and sends the resultant mixture to one or more boilers to fuel the boilers and/or other components of the facility. The boilers create steam, which can be used for a variety of purposes such as (1) turning a turbine to produce electrical energy, (2) sending the steam to a building for comfort heat, (3) sending the steam to a digester at a wastewater treatment plant to warm the digester, which thereby speeds the rate of digestion of biological material inside of the digester, and/or (4) any other desired usage of the boiler steam.

Both synthesis gas and biogas are fuels created from waste products. Synthesis gas generally comprises hydrogen, carbon monoxide, and carbon dioxide. Synthesis gas is typically made utilizing refuse derived fuel (“RDF”), which typically comprises various recycled materials such as waste wood, plastic, paper, cardboard, and/or other similar waste materials. Biogas is a type of biofuel and is derived from biogenic materials. Biogas is broadly characterized as any gas or combination of gases that are produced by the biological breakdown of organic materials in the absence of oxygen. Biogases (and/or biogas mixtures) may be made from biological materials such as waste water, pre-sludge, sludge, corn, and/or any other biological material. The sources of both the synthesis gas and the biogas are typically materials present in the environment (not mined from under the surface of the earth) and can therefore be argued to be carbon neutral.

Wastewater treatment generally involves separating solid organic materials, i.e., biosolids, from the water so that the water may be treated until it is sufficiently cleansed of contaminants to be returned to the environment. Biosolids material may either be disposed of in a landfill or, more preferably, processed to make fertilizer, a valuable commodity. Biosolids may also be subjected to anaerobic digestion/fermentation to yield combustible biogas, such as methane, a valuable energy source that can be used to ultimately fuel electrical turbines or other equipment. If biogas/biosolids are not used effectively, such use can contribute to detrimental greenhouse gases.

Numerous problems exist with respect to known prior art systems. For example, waste materials are often inefficiently disposed of rather than effectively processed to yield valuable, useable energy. In addition, various present methods of processing waste materials to render useable energy could be significantly improved. With regard to unused biogas, in some facilities, excess biogas generated during summer months may be burned/flared rather than used, which can be aesthetically and/or environmentally detrimental.

A further problem exists in that various prior art methods of processing biosolids to produce biogas and/or fertilizer are cost prohibitive because they typically must utilize significant amounts of outside energy to perform the processing steps. Additionally, prior art wastewater treatment plants may be inhibited from changing the plant's design for fear of failure and the associated expense of attempting such changes.

It is not uncommon for most treatment facilities to exhibit these types of inefficiencies. Further, these problems are exacerbated by the utilization of multiple parties for each phase of waste treatment. For example, in the treatment of wastewater, one party, such as a local government, may be responsible for pumping untreated wastewater to a treatment plant. A second party, perhaps a private contractor, may be responsible for one or more phases of the wastewater treatment process, such as, separating biosolids from the water, subjecting the biosolids to aerobic and/or anaerobic digestion, and/or subjecting the water or biosolids to one or more chemical or filtration processes prior to sending the treated biosolids to a landfill or to a fertilizer production service. A third party, such as a fertilizer production company, may collect treated biosolids from the wastewater treatment plant and subject same to further treatment in order to yield a commercially viable fertilizer. As may be seen, these prior art wastewater treatment operations that involve multiple parties performing different functions may lead to inefficiencies. One such inefficiency is that each waste processing function has energy requirements and the energy to fuel a particular process is often purchased from an off-site resource such as an electric or natural gas utility. Furthermore, many processes generate a significant amount of energy that is unutilized and wasted rather than captured and used.

The system described herein may be used at a wastewater treatment plant or another comparable facility that produces or otherwise has biogas. For example, a wastewater treatment plant has digesters onsite and may also have buildings that require electricity and comfort heat. One or more boilers, or some other type of equipment, can be fueled by synthesis gas, biogas, and/or combinations thereof. Utilizing the system and method described herein to provide fuel to the facility in order to power lights, pumps, and/or other equipment may be cheaper than purchasing electricity from an offsite electric or gas utility or otherwise purchase oil or other fossil fuels to be used on-site to generate power.

Further, the method and system disclosed herein may also overcome other inefficiencies of the prior art. For example, the system efficiently leverages various waste streams to produce a significant amount of useable energy, which in turn, reduces the overall cost of processing such waste. One such example is that a first type of waste material, refuse derived fuel, can become a highly effective and practical fuel source for various components including, for example, boilers/turbines, when the RDF fuel is converted to synthesis gas and then combined with biogas prior to combustion in the boiler(s).

It is contemplated that different waste materials may be processed in one integrated system, and that one or more phases of fertilizer production may be integrated into such a system. Linking particular functions of the system together is highly advantageous from a commercial standpoint. The novel system disclosed herein combines (1) the process of converting RDF fuel to synthesis gas, (2) the process of converting biosolids to biogas, and (3) the process of producing fertilizer from biosolids. As a result of these synergistic combinations, certain phases of each process can complement each other, resulting in substantial processing efficiencies that achieve substantial cost savings. Therefore, utilizing these efficiencies makes each individual process step and the overall process more efficient than each individual process step may be on its own and reduces the need to purchase energy from off-site resources.

### SUMMARY OF INVENTION

In one aspect of the present invention, an energy conserving wastewater treatment system capable of being fueled by alternate fuel sources comprises a synthesis gas generator that produces synthesis gas from a fuel and an organic waste digester that produces biogas. A combined synthesis gas and biogas storage reservoir is in communication with both the synthesis gas generator and the organic waste digester. At least one boiler is in communication with the combined synthesis gas and biogas storage reservoir.

In a different aspect of the present invention, an energy conserving wastewater treatment system capable of being fueled by alternate fuel sources includes a synthesis gas generator that produces synthesis gas from refuse derived fuel and gas cleaning equipment that cleans the synthesis gas. A first heat transfer apparatus transfers heat from the synthesis gas and sends the heat to a sludge dryer. An organic waste digester produces biogas from anaerobic digestion of biosolids. The system further includes biogas cleaning equipment that cleans the biogas. At least one boiler receives at least one of the synthesis gas or the biogas or a combination thereof. An electricity generating apparatus is in communication with the boiler.

In yet another aspect of the present invention, a method of conserving energy in a wastewater treatment plant comprises the steps of producing synthesis gas from a fuel using a synthesis gas generator and producing biogas from the anaerobic digestion of biosolids using an organic waste digester. Heat is captured from the synthesis gas production and sent to a biosolids dryer. At least one boiler is provided for combusting at least one of either the synthesis gas or biogas. Steam produced by the boiler is sent to both a turbine and to the organic waste digester.

### BRIEF DESCRIPTION OF THE DRAWINGS

FIG. 1 is a schematic view showing a system for processing alternative fuels that uses a multiple boiler system;

FIG. 2 is am isometric representation of a different embodiment of a system for processing alternative fuels that uses one boiler;

FIG. 3 is a partial fragmentary, exploded view of FIG. 2;

FIG. 4 is further partial fragmentary exploded view of FIG. 2, showing the boiler of FIG. 2 in further detail;

FIG. 5 is a three-dimensional schematic showing a phosphorous/nitrogen enhancing subsystem used in fertilizer production;

FIGS. 6A and 6B are schematic views of another embodiment of a system for processing alternative fuels having a direct feed with separate synthesis gas and biogas conduits feeding a boiler; and

FIG. 7 is a block diagram showing various process steps involved in one or more embodiments.

### DETAILED DESCRIPTION OF THE DRAWINGS

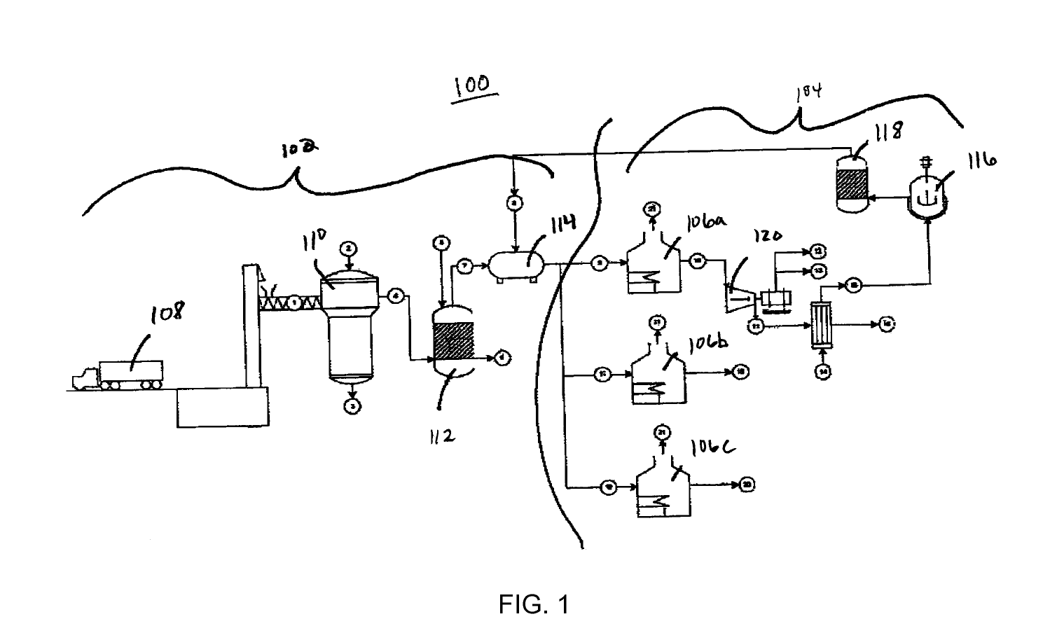

Turning to FIG. 1, a schematic view of a first embodiment of a system 100 and method for processing alternate fuel sources is shown. A facility contemplated by the present disclosure includes a fuel generation area 102 that supplies fuel to an operational area 104 of the facility. The fuel generation area 102 is preferably located in an area adjacent the operational area 104 of the facility and/or is fluidly connected to allow fuel generated by the fuel generation area 102 to be delivered to the operational area 104 to provide power thereto. The fuel may be utilized in various manners as known in the art. For example, in one embodiment, fuel is provided to one or more pieces of equipment, such as boilers 106a-106c. The boilers 106a-106c utilize the fuel in various manners as described hereinbelow.

Still referring to FIG. 1, a vehicle 108 typically delivers an alternate fuel such as RDF to the facility. The fuel is provided onto a conveyor or other suitable transport equipment, which sends the alternate fuel to a gasifier 110. The alternate fuel comprises primarily recycled residual materials such as recycled wood, fiber, plastic, and the like. While the alternate fuel may be supplied to the facility in any volume or weight increment, payload deliveries comprising about fifteen tons to about twenty five tons are typical.

The alternate fuel may include contaminants, for example, such as trap metals and other non-conforming materials. The contaminants are normally present in an amount less than about 5%, and more preferably are present in an amount less than about 3%, and most preferably are present in an amount less than about 1% of the alternate fuel on a dry weight basis. The alternative fuel is preferably provided in a form wherein each particle's overall size is about 8 inches or less, more preferably about 6 inches or less, and most preferably about 4 inches or less. Further, it is preferable that the alternative fuel contain less than about 5% of metal content, more preferably less than about 3% of metal content, and most preferably less than about 1% of metal content.

The alternate fuel is provided to the gasifier 110 and is converted to synthesis gas. In one embodiment, the gasifier 110 is a plasma arc gasifier, which is available from Westinghouse Plasma Corporation®. In a different embodiment, the gasifier 110 comprises a fluidized bed reactor, such as a reactor furnished by Frontline Bioenergy of Ames, Iowa. In yet another embodiment, the gasifier may be other types of gasifiers as known in the art. The gasifier 110 heats the alternate fuel to temperatures sufficient to convert a majority of the alternate fuel to synthesis gas. The preferred temperature varies according to the amount and exact composition of the alternate fuel, but the alternate fuel is preferably heated to a temperature between about 3,000° F. to about 15,000° F., and more preferably between about 7,000° F. to about 12,000° F., and most preferably about 10,000° F. The synthesis gas that is formed exits the gasifier 110 at a temperature lower than the heating temperature. For example, the synthesis gas typically exits the gasifier 110 at a temperature of between about 3,000° F. to about 3,500° F. The resultant synthesis gas comprises primarily carbon monoxide, hydrogen, carbon dioxide, methane, and other trace gases. The synthesis gas preferably contains less than about 10% residual materials when exiting the gasifier 110.

Still referring to FIG. 1, the synthesis gas exits the gasifier 110 and is sent to a gas cleaning and conditioning system 112. In the gas cleaning and conditioning system 112, the synthesis gas is scrubbed of contaminants such as trace sulfur gases, halogens, metals, and particulates. These contaminants may be disposed of in any manner as known in the art and/or may be periodically taken away to a landfill.

Optionally, a heat exchanger (not shown) as known in the art may be provided between the gasifier 110 and the gas cleaning and conditioning system 112 to cool the synthesis gas before it enters the gas cleaning and conditioning system 112. The gases may be cooled in the heat exchanger with exchange air forwarded as combustion air intake to the boilers 106a-106c and synthesis gas stripped of significant sentient energy sent to a gas scrubber (not shown). Any residual components may be water quenched and transported and disposed of in a landfill. Quench water may then be conveyed to the wastewater treatment plant inlet for treatment. In addition to cooling the synthesis gas, the heat exchanger may send heat/hot air to the intake of one or more of the boilers 106a-106c, thereby increasing the efficiency of the boilers.

After exiting the gas cleaning and conditioning system 112, the scrubbed synthesis gas is sent to a storage tank 114. In one embodiment, one storage tank is provided. In other embodiments, more than one storage tank 114 is utilized in manners consistent with this disclosure. The synthesis gas is combined with biogas in the storage tank 114 as described in more detail hereinbelow.

In a wastewater treatment facility, biogas is typically created when organic or biological material is contained within and allowed to ferment within one or more digesters 116 in the absence of air. The biogas that is formed is sent to a biogas cleaning system 118 in manners known to those in the art. The biogas cleaning system 118 removes sulfur compounds, siloxanes compounds, and any other undesirable components.

After exiting the biogas cleaning system 118, the resultant biogas is transported to the storage tank 114, wherein the biogas and the synthesis gas are combined to form fuel. The resultant biogas/synthesis gas has an increased heating value such that the resultant gas is easier to burn in “conventional” natural gas fired equipment as compared to synthesis gas alone, biogas alone, or other fuels. The synthetic gas is provided to the storage tank 114 at a rate of between about 50,000 lbs/hr to about 80,000 lbs/hr, and more preferably between about 65,000 lbs/hr to about 75,000 lbs/hr, and most preferably about 68,000 lbs/hr. The higher heating valve (HHV) of the synthesis gas is about 5,000 BTU/lb at about 68,000 lbs/hr. The biogas is provided to the storage tank 114 at a rate of between about 5,000 lbs/hr to about 25,000 lbs/hr, more preferably at a rate of between about 10,000 lbs/hr to about 20,000 lbs/hr, and most preferably at a rate of about 14,815 lb/hr. The higher heating valve of the biogas is about 10,125 BTU/lb at about 14,815 lb/hr.

As shown in FIG. 1, the storage tank 114 serves as a fuel reservoir for one or more boilers 106a-106c. Various types of boilers 106a-106c may provide power to operate various components within the facility. For example, the boiler 106a could be a high pressure steam generation system, the boiler 106b could be a low pressure steam generation system, and the boiler 106c could be a heat transfer oil heating system. In one particular example, boiler 106a may route resultant steam to a turbine/electrical generator 120 to produce electricity. The resultant electricity may be used to power lights and/or other devices, e.g., the electric could be sent to one or more condensers, pumps, or other devices that assist in the operation of the facility. One such example is when the pump is used to propel waste water or other organic material into the digester 116. One or more of the boilers 106a-106c may also send condensate/steam to the digester 116 to warm the digester 116, thereby increasing the rate of biological digestion. In one embodiment, the high pressure steam is used to turn a high efficiency steam turbine/electrical generator to produce electrical power, the low pressure steam is used for process and comfort heating, and the heat transfer oil is used to dry wet sludge. Further, condensing the steam under vacuum from the turbine generator can be used to create hot water for digester heating requirements.

Portions of the various streams of the process, such as the biogas and synthesis gas streams, may also be recycled or diverted to other areas of the facility as will be explained in more detail hereinbelow. For example, low pressure steam may be conveyed to the digesters 116 and used to assist with heating requirements for the wastewater treatment plant.

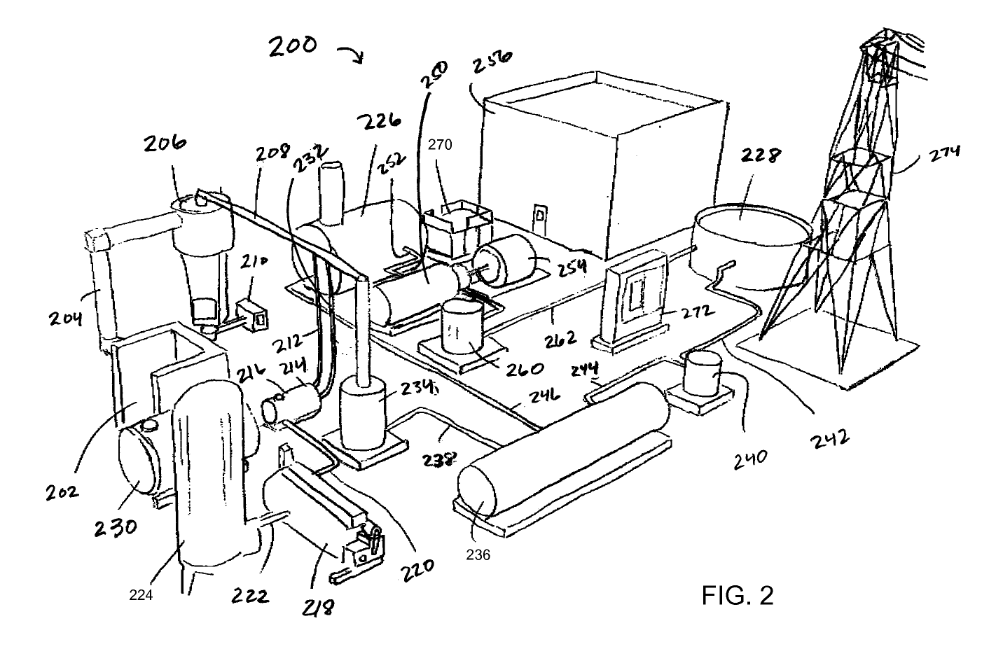

Referring to Tables 1 and 2 hereinbelow, various heat and materials data are provided as an example from a treatment plant utilizing various components of the present invention. In particular, the Tables 1 and 2 reflect the heat and materials data for the embodiment discussed with respect to FIGS. 2-4. However, it should be noted that optimal heat and materials values could vary significantly depending on a variety of factors including the location of the plant and local water chemistry, the composition of wastewater solids at a particular plant and time of year (e.g., summer versus winter), the volume of wastewater at a particular plant, and ambient temperature. Therefore, it is understood that one of ordinary skill in the art could determine the appropriate operating parameters for a particular plant, depending on these and possibly other factors.

The data shown in Tables 1 and 2 provide a tabulation of the mass and energy entering, traveling through, and leaving the system of the system of this embodiment and the energy efficiency and viability of the system at a point in time. The numbers are calculated utilizing actual and “typical” chemical compositions for the feedstocks, synthesis gas, and biogas. Also incorporated into these calculations are system and equipment efficiencies that are typical for the type and size of the equipment used. In addition to the factors discussed hereinabove, the values in Tables 1 and 2 will vary based on operational levels of the system (e.g., 50 percent, 75 percent, or 100 percent of system capacity), the time of the year (there will be more heat loss from the system in the winter season as compared with the summer season and more biogas will be generated in the summer), and energy demand of the facility. During the operation of the system, operating parameters in the system such as temperatures, flow rates, and pressures are monitored and used to calculate real time operating values that are then incorporated into spreadsheets similar to Tables 1 and 2 and used to calculate the overall efficiency of the system and its unit operations.

TABLE 1

| ID | Processes | 1 | 2 | 3 | 4 | 5 | 6 | 7 | 8 |
|---|---|---|---|---|---|---|---|---|---|
| A | Thermal | 3.62E+08 | 2.54E+07 | 2.45E+06 | 3.41E+08 | | | 2.81E+08 | 1.36E+08 |
| | Energy | | | | | | | | |
| | (BTU/hr) | | | | | | | | |
| B | Electrical | | | | | | | | |
| | Energy | | | | | | | | |
| | (MWhr) | | | | | | | | |
| C | Useful Energy | | | | | | | | |
| | (MWhr) | | | | | | | | |
| D | Parasitic Load | | | | | | | | |
| | (MWhr) | | | | | | | | |
| E | RDF (TPH) | 25 | | | | | | | |
| F | Oxygen | | 23,667 | | | | | | |
| | (lb/hr) | | | | | | | | |
| G | Bed Material | | 4,000 | | | | | | |
| | (lb/hr) | | | | | | | | |
| H | Slag (lb/hr) | | | 2,778 | | | | | |
| I | Syn-Gas | | | | 68,000 | | | 67,819 | |
| | (lb/hr) | | | | | | | | |
| J | Water & | | | | | 54,000 | | | |
| | Caustic (lb/hr) | | | | | | | | |
| K | Process Drain | | | | | | 55,000 | | |
| | (lb/hr) | | | | | | | | |
| L | Digester Gas | | | | | | | | 13,373 |
| | (lb/hr) | | | | | | | | |
| M | Steam 850 psi | | | | | | | | |
| | (lb/hr) | | | | | | | | |
| N | Steam 100 psi | | | | | | | | |
| | (lb/hr) | | | | | | | | |
| O | Condensate | | | | | | | | |
| P | Cooling Water | | | | | | | | |
| | (lb/hr) | | | | | | | | |
| Q | Hot Oil (lb/hr) | | | | | | | | |
| R | Air (lb/hr) | | | | | | | | |
| S | Flue Gas | | | | | | | | |
| | (lb/hr) | | | | | | | | |
| T | Heat Loss | | | | 2.00E+07 | | 1.50E+07 | | |
| | (BTU/hr) | | | | | | | | |

| ID | Processes | 11 | 12 | 13 | 14 | 15 | 16 | 17 | 18 | 19 | 20 | 21 |
|---|---|---|---|---|---|---|---|---|---|---|---|---|
| A | Thermal | 2.28E+08 | | | | | | | | | | |
| | Energy | | | | | | | | | | | |
| | (BTU/hr) | | | | | | | | | | | |
| B | Electrical | | | | | | | | | | | |
| | Energy | | | | | | | | | | | |
| | (MWhr) | | | | | | | | | | | |
| C | Useful Energy | | 25 | | | | | | | | | |
| | (MWhr) | | | | | | | | | | | |
| D | Parasitic Load | | | 5 | | | | | | | | |
| | (MWhr) | | | | | | | | | | | |
| E | RDF (TPH) | | | | | | | | | | | |
| F | Oxygen (lb/hr) | | | | | | | | | | | |
| G | Bed Material | | | | | | | | | | | |
| | (lb/hr) | | | | | | | | | | | |
| H | Slag (lb/hr) | | | | | | | | | | | |
| I | Syn-Gas (lb/hr) | | | | | | | | | 6,203 | | |
| J | Water & | | | | | | | | | | | |
| | Caustic (lb/hr) | | | | | | | | | | | |
| K | Process Drain | | | | | | | | | | | |
| | (lb/hr) | | | | | | | | | | | |
| L | Digester Gas | | | | | | | | | | | |
| | (lb/hr) | | | | | | | | | | | |
| M | Steam 850 psi | | | | | | | | | | | |
| | (lb/hr) | | | | | | | | | | | |
| N | Steam 100 psi | | | | | | | | 2.58E+07 | | | |
| | (lb/hr) | | | | | | | | | | | |
| O | Condensate | 231,255 | | | | 231,255 | | 23,866 | | | | |
| P | Cooling Water | | | | 6.04E+06 | | 6.04E+06 | | | | | |
| | (lb/hr) | | | | | | | | | | | |
| Q | Hot Oil (lb/hr) | | | | | | | | | | 264,520 | |
| R | Air (lb/hr) | | | | | | | 27,600 | | | 52,700 | |
| S | Flue Gas | | | | | | | | | | | 429,431 |
| | (lb/hr) | | | | | | | | | | | |
| T | Heat Loss | 7.00E+06 | 1.00E+06 | | | | | | 5.00E+06 | | 2.00E+06 | 2.00E+06 |
| | (BTU/hr) | | | | | | | | | | | |

TABLE 2

| INPUT | BTU/hr | OUTPUT | BTU/hr |
|---|---|---|---|
| Phase 1 | | | |
| Alternate Fuel | 362,120,000 | Synthesis Gas (LHV) | 281,417,000 |
| Coke | 25,425,000 | Sensible Heat | 92,503,000 |
| Torch Power | 6,375,000 | Heat Loss | 20,000,000 |
| Total | 393,920,000 | | 393,920,000 |
| Phase 2 | | | |
| Digester Gas | 150,000,000 | Thermal Heaters | 63,000,000 |
| Synthesis Gas | 281,417,000 | HP Steam | 336,015,000 |
| Sensible Heat | 10,598,000 | LP Steam | 33,000,000 |
| | | Heat Loss | 10,000,000 |
| Total | 442,015,000 | | 442,015,000 |
| Phase 3 | | | |
| HP Steam | 336,015,000 | Power | 102,364,260 |
| | | Sensible/Latent Heat | 227,556,000 |
| | | Heat Loss | 6,094,740 |
| Total | | | 336,015,000 |
| Primary Inputs | | Primary Outputs | |
| Alternate Fuel | 362,120,000 | Power | 102,364,260 |
| Coke | 25,425,000 | LP Steam | 33,000,000 |
| Torch Power | 6,375,000 | Thermal Heaters | 63,000,000 |
| Digester Gas | 150,000,000 | Heat Loss | 36,094,740 |
| | | Digester Heating | 40,000,000 |
| | | Latent Heat | 259,000,000 |
| | | Sensible Heat | 10,461,000 |
| Total | 543,920,000 | | 543,920,000 |

Now turning to a different embodiment of the system for processing alternative fuel, a one boiler system is depicted in FIGS. 2-4 and includes a plant 200 having an RDF dock 202 that receives refuse derived fuel (RDF) delivered by a truck (not shown). The RDF fuel is conveyed through a conduit 204 to a suitable gasification unit 206 to convert the RDF fuel into synthesis gas. Any gasification unit 206 consistent with the present disclosure may be used in this embodiment including the unit manufactured by Frontline System of Ames, Iowa. The gasification unit 206 may be supplied with a desired amount of oxygen, and/or preferably ambient air, to assist in the gasification process, depending on environmental conditions and/or the type of RDF fuel utilized. The synthesis gas exits the gasification unit 206 and travels through a second conduit 208 to another system component as will be described below. A conventional slag quencher/remover 210 may be optionally provided to remove contaminants from the synthesis gas during synthesis gas production.

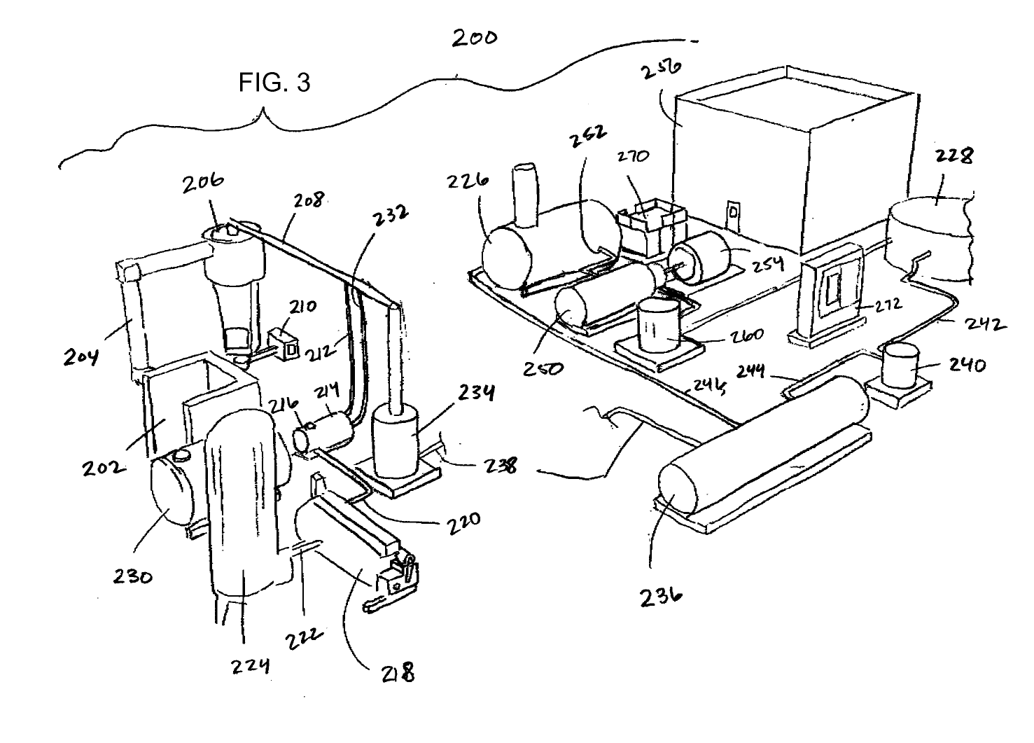

As best seen in FIGS. 2 and 3, the synthesis gas travels through the second conduit 208 to an intake conduit 212 of a heat exchanger 214, which is preferably a heat recovery steam generator (“HRSG”). The HRSG serves various functions. The HRSG cools the synthesis gas, which is a helpful and/or necessary step to increase the density of the synthesis gas to facilitate gas scrubbing in a synthesis gas scrubber 216, if such a scrubber is utilized. Additionally, the HRSG sends steam to the biosolids dryer/pelletizer 218 through a third conduit 220. The steam from the HRSG assists in drying biosolids within a bisolids dryer 218. Using the steam from the HRSG is more advantageous than allowing heat from the cooling synthesis gas to escape into the ambient environment because the heat transferred from the HRSG to the biosolids dryer 218 lowers the cost of drying the biosolids.

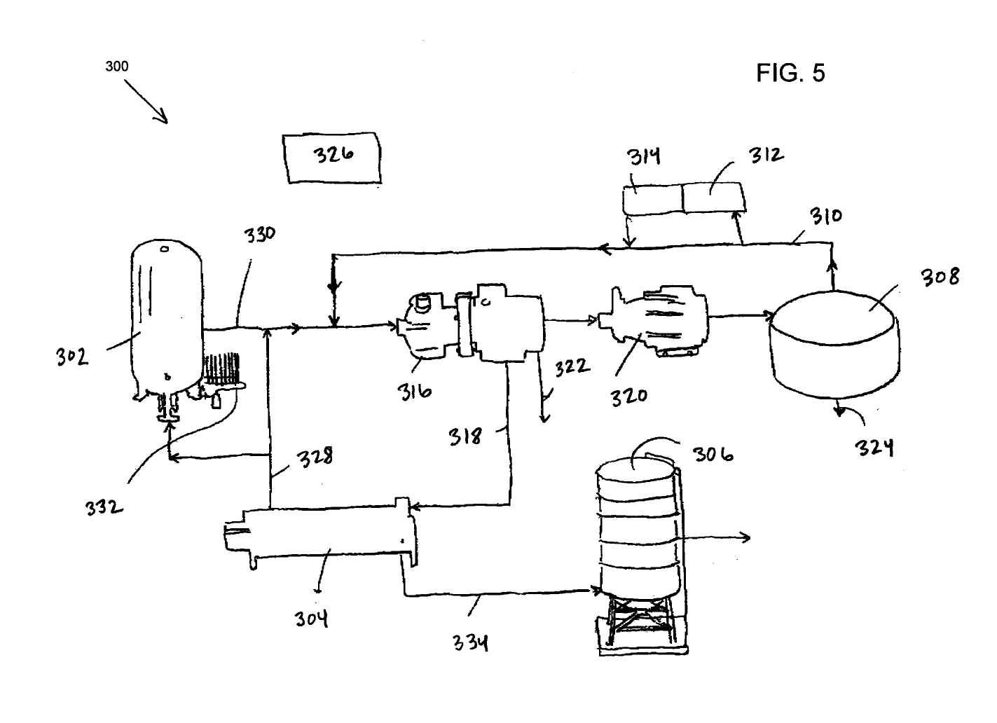

Valuable fertilizer is created in a fertilizer production process within the system 200 for processing alternative fuel by subjecting the biosolids to various processing steps. In particular, when the biosolids in the dryer 218 reach a desired level of dryness, the biosolids are then transferred via a fourth conduit 222 to a storage silo 224 so that the biosolids therein may be picked up by a truck or other transport to a fertilizer manufacturer or supplier. Any suitable biosolids dryer 218 as known in the art may be implemented, such as a rotadisc dryer purchased from Haarslev Industries of Denmark. At any suitable point in the fertilizer production process, a dust control product such as Dustrol™ is optionally applied to the biosolids to reduce dust, as is generally known in the art. Also, the screening of the fertilizer to a desired particle size may be performed either on-site or off-site. Further details on the bisolids drying procedure and the screening of biosolids material are discussed hereinbelow with respect to FIG. 5.

It should be noted that an additional conduit (not shown) may be optionally provided to route steam from the HRSG to any other desired location in the plant 200. For example, such steam could be sent to a boiler 226 to warm the water therein, or such steam could be sent to a biosolids waste digester 228 to circulate around the digester 228, thereby warming the biosolids therein to speed the rate of anaerobic digestion. The digester 228 may additionally or alternatively be heated by hot water that is recovered from the biosolids dryer 218. The dryer 218 produces steam vapors that are condensed with a small amount of water to make hot water from the latent heat within the vapors. This hot water may be circulated to the digester 228 heating system that heats the contents of the digester reactor to keep the sludge at a preferred temperature, which allows for the biological activity to break down the organic matter into digester gas. The HRSG may provide a second source of hot water for heating the digesters in addition to the turbine condenser hot water system that was previously discussed.

Although an HRSG is discussed with respect to this embodiment herein, it is contemplated that other types of heat exchangers as known in the art may be utilized in the embodiments disclosed herein.

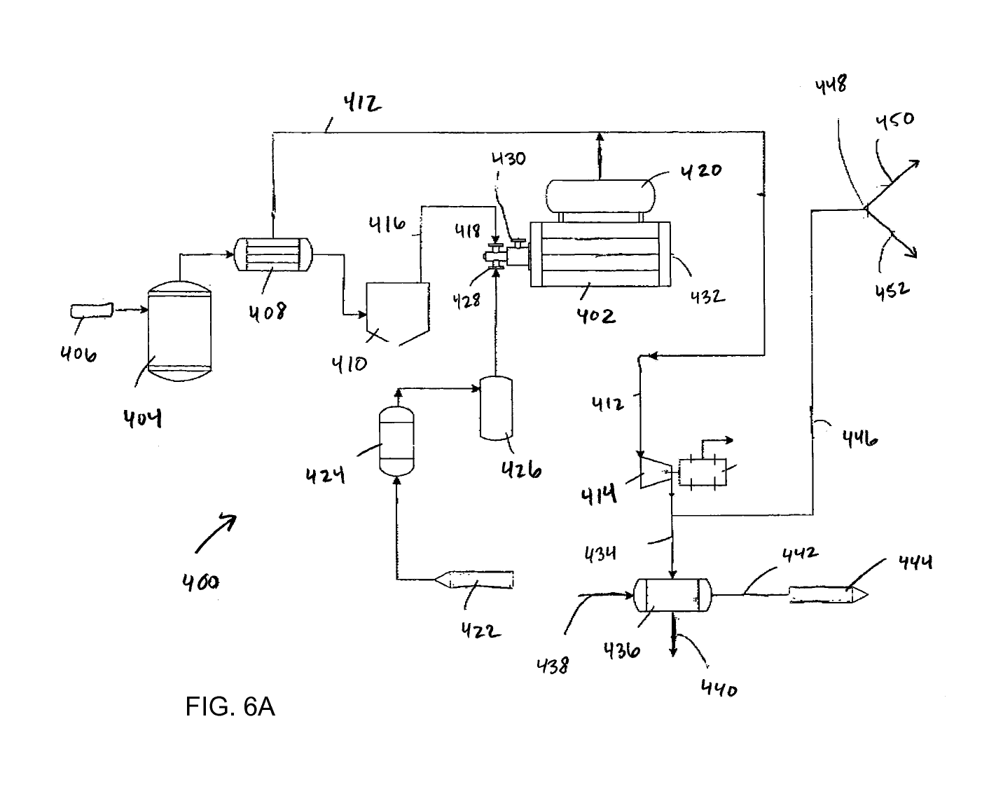

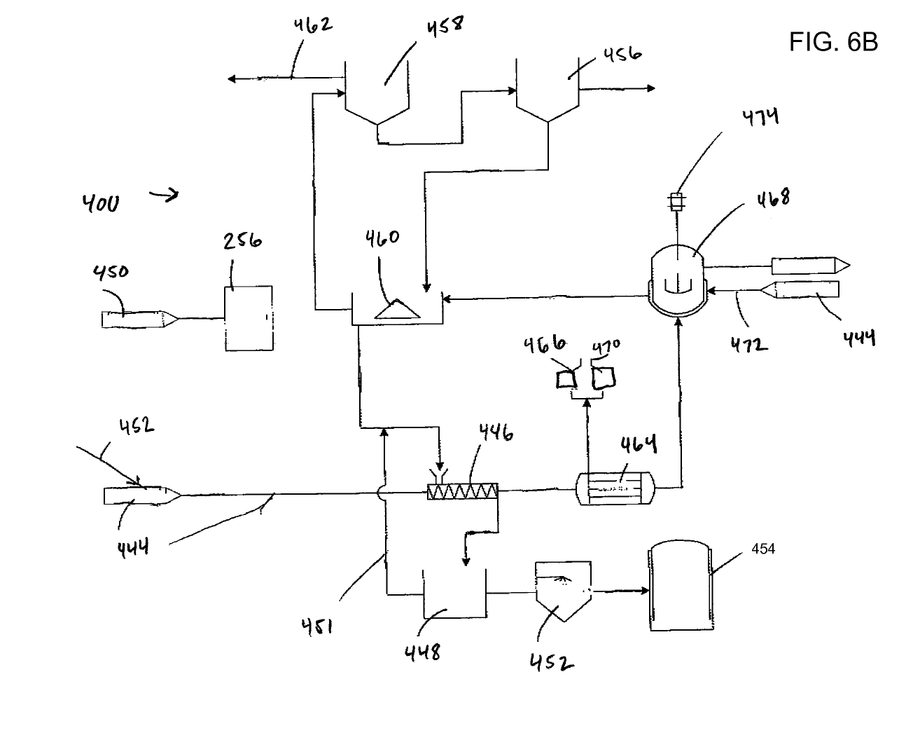

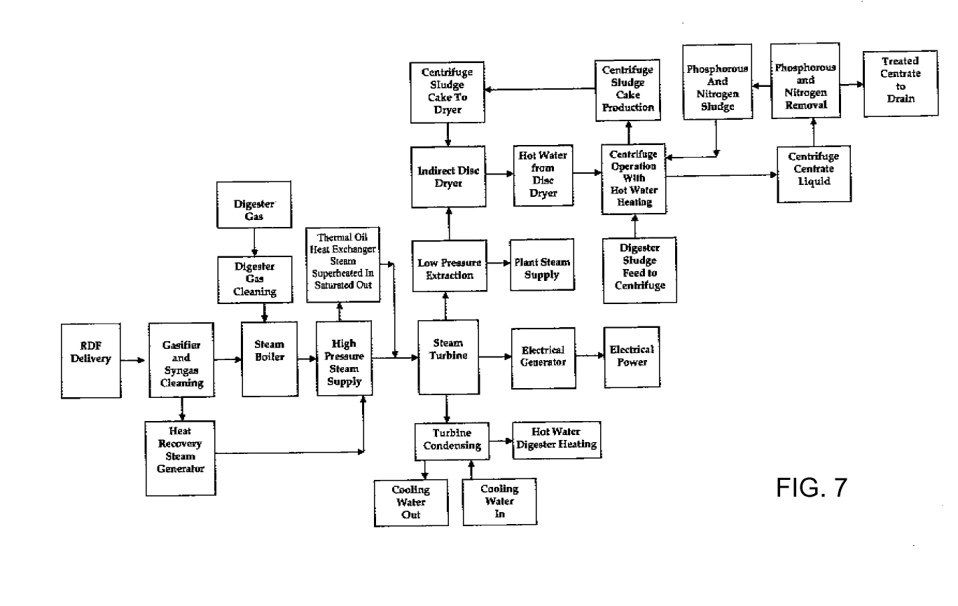

Still referring to FIGS. 2 and 3, a vapor condenser 230 is provided to process vapors from the biosolids dryer 218. Any suitable vapor condenser may be used including ones manufactured by Haarslev Industries of Denmark. As described in greater detail hereinbelow with respect to FIGS. 6A and 6B, the vapors from the dryer 218 are typically first passed through a conventional cyclone separator (not shown) to remove any dust entrapped within the vapors, and the dust is returned to the dryer 218. The dust free vapors then enter the condenser 230, which may be connected to the silo 224 of the dryer 218.

Once the synthesis gas reaches a desired reduced temperature in the HRSG, such as about 700° F., the reduced temperature synthesis gas travels through a fifth conduit 232 (see FIG. 3) to a synthesis gas scrubber 234. The synthesis gas scrubber 234 is typically a multi-unit operation that employs carbon granules and removes moisture, sulfur, siloxanes, and/or other contaminants which may be detrimental to boiler operation. From the synthesis gas scrubber 234, the clean synthesis gas travels to a reservoir 236 through a sixth conduit 238.

Similarly, the biosolids waste digester 228 sends biogas produced therein to biogas cleaning equipment, such as a conventional biogas scrubber 240, via conduit 242. Once the biogas is cleaned in the biogas scrubber 240, the biogas is sent via conduit 244 to the reservoir 236 for storage. Combining the cleaned biogas with the cleaned synthesis gas in the reservoir 236 is advantageous because, as noted previously, the synthesis gas by itself has lower energy than the biogas. By adding higher energy biogas to the synthesis gas, the resultant gas mixture has a higher energy than the synthesis gas itself, thereby making the gas mixture a more desirable fuel for a boiler 226. In addition, as noted previously, the rate of biogas production might be slower in some plants than the rate of synthesis gas production. Therefore, combining these gases in some instances creates a useable quantity of fuel for the boiler 226 than might otherwise be available.

After the biogas and synthesis gas are combined, the boiler 226 draws the mixed gas from the reservoir 236 via conduit 246 and sends steam to an electricity generating apparatus provided in the form of a steam turbine 250 via conduit 252. The steam turbine 250 is operably connected to an electric generator 254 to produce electricity. The electricity may be sent to a plant building 256, to onsite pumps or lights (not shown), to other system components, and/or may be sent offsite of the plant 200 for sale or other use. A suitable turbine 250 and generator 254 may be used as known in the art.

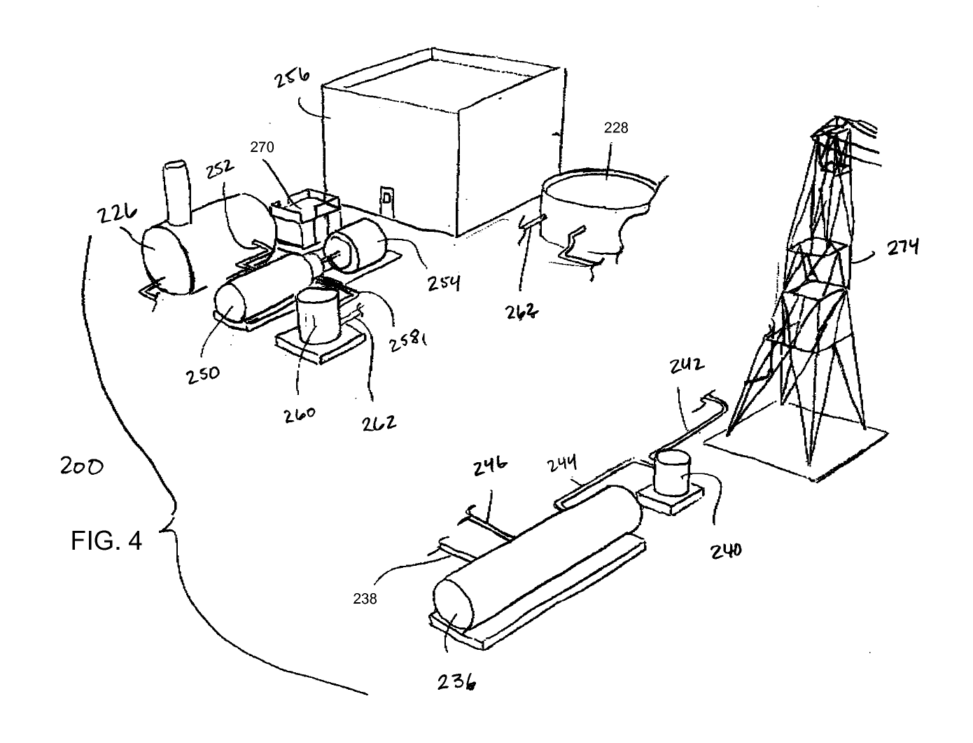

As best seen in FIG. 4, a conduit 258 connects the steam turbine 250 to a hot water storage tank 260. In operation, high pressure, high temperature steam leaves the boiler 226 to turn the steam turbine 250. Such steam transfers its energy to turning the turbine 250 and the resultant lower pressure, lower temperature steam travels from the steam turbine 250 to the storage tank 260. The warm water in the storage tank 260 can then be sent through a conduit 262 to the biosolids digester 228 to circulate around the digester 228, which warms the biosolids therein to speed the rate of digestion. Preferably, the temperature within the digester 228 is maintained at a temperature of above about 80° F., more preferably above about 90° F., and most preferably at about 96° F. Hot water in the storage tank 260 is typically retained at a temperature of about 150° F. When a temperature of about 96° F. is achieved in the digester 228, hot water flow is typically stopped.

A condenser 270 may be provided in the alternative fuel processing system 200 to supply hot water to various components within the system 200. Low pressure steam from the turbine 250 travels under vacuum to the condenser 270 where it is condensed to hot water. The hot water is then sent to storage tank 260 where it can then be routed to one or more components including the dryer 218, the boiler 226, the digester 228, a centrifuge (not shown), building 256, and/or any other components within any of the systems described herein.

Additionally, the condenser 270 generates a vacuum to increase the turbine 250 efficiency. By condensing the water, wasted water is minimized and the turbine runs more efficiently. The condenser 270 is typically a two-stage condensing system that utilizes hot water to capture the heat from the latent heat of the steam into sensible heat in the hot water. Additional cooling water is provided by clean effluent sewage water that is used to complete the condensing process and to discharge heat to the sewage water. Condensing steam from the turbine provides numerous beneficial uses as opposed to wasting the heat to the sewage water. The amount of hot water that is created by changing the latent heat to sensible heat provides heat to the digesters and centrifuge feed by converting the steam back to water.

Referring again to FIGS. 2 and 3, a suitable control apparatus 272 for the system is also provided. The control apparatus 272 is capable of using off-site electrical power from power lines 274, but may also be designed to additionally receive electricity from the turbine 250.

Turning to FIG. 5, the biosolids fertilizer production in any of the embodiments disclosed herein may optionally include a phosphorous/nitrogen enhancing loop or subsystem 300, located generally between the waste digester and the fertilizer silo. The phosphorous loop 300 increases the concentration of phosphorous and nitrogen in the biosolids in order to ultimately produce a more effective fertilizer, while also improving the quality of the waste water effluent from the plant. The phosphorous loop 300 includes various components in communication with a heated anaerobic waste digester 302, biosolids dryer 304 and storage silo 306. The digester 302 may be similar or identical to the digester 116 of FIG. 1 or the digester 228 of FIG. 4. Sludge (not shown) exits a thickening tank 308 through a suitable conduit 310 using a conventional pump 312. The pump 312 optionally feeds the sludge through an electromagnetic flow meter 314. Additionally, the pump 312 preferably includes a variable frequency drive to permit adjustment with regard to dewatering capacity. The sludge is fed into a centrifuge 316 from the thickening tank 308. The high centrifugal force of the centrifuge promotes instantaneous sedimentation of the sludge. The centrifuge 316 is preferably powered by low pressure steam generated from other parts of the system, such as, for example, low pressure steam sent from the condenser 270 (see FIG. 2). The centrifuge 316 preferably incorporates a feed system that introduces a polymer simultaneously into a decanter bowl of the centrifuge to aid in flocculation of the sludge.

Still referring to FIG. 5, the centrifuge 316 sends biosolids cake (not shown) to the dryer 304 via conduit 318. In one embodiment, the conduit 318 comprises an external screw conveyor (not shown). After separation, the centrifuge 316 sends any remaining slurry into a chemical treatment apparatus 320. The chemical treatment apparatus 320 precipitates phosphorous and nitrogen from the slurry to form a thickened chemical sludge having phosphorous and nitrogen therein. The thickened chemical sludge is sent into the thickening tank 308 and is ultimately sent back to the centrifuge 316. The centrifuge 316 has a separate conduit 322 that sends clarified liquid out of the centrifuge 316 to either a sewer or another location in the plant for further treatment. The centrifuge 316 is preferably about 90% efficient, which means that of the sludge material entering the centrifuge 316, 10% exits as centrate through conduit 322.

Any centrifuge as known in the art may be used, such as, for example a decanter centrifuge manufactured by Alfa Laval. Further, the thickening tank 308 is preferably a gravity thickening tank or a dissolved air flotation tank, but other thickening tanks as known in the art may be used. The thickening tank 308 sends treated centrate to a sewer (not shown) via a suitable conduit 324.

A suitable control/starter panel 326 is used to start/stop or otherwise control all equipment in the subsystem 300. The panel 326 may optionally be incorporated into the control 272 of FIG. 2.

Returning again to the dryer 304 operation, if the biosolids entering the dryer 304 are too wet, the biosolids are generally too difficult to process. Specifically, a roughly 45% solids composition exists in a gummy or sticky phase that is difficult to process using a conventional drying apparatus. Therefore, a portion of the dryer's 304 dried biosolid output is recycled back into the centrifuge 316 via conduit 328. Dried biosolid output from the dryer 304 is typically comprised of about 90% to about 92% dry solids composition. Sludge exiting the thickening tank 308 comprises about 25% dry solids composition. The dried output from the dryer 304 is mixed with the sludge from the tank 308 in a ratio of about 2:1, dried-output-to-sludge ratio (e.g., two pound to one pound), to achieve a preferred approximately 68% dry particle composition entering the centrifuge 316. A paddle mixer (not shown), well known in the art, may be optionally used to mix the dried output from the dryer 304 with the sludge from the thickening tank 308 prior to entering the centrifuge 316.

In the dryer 304, steam flow, residence time, and temperature can be regulated as necessary to achieve an appropriate evaporation rate. Further details of the dryer 304 operation are discussed below in relation to FIG. 6B.

The centrifuge 316 is also fed by the anaerobic digester 302 via conduit 330. As discussed previously, any digester disclosed herein, such as digester 116 (FIG. 1), digester 228 (FIG. 6), and digester 302, send biogas ultimately to one or more boilers. However, remaining biosolids in the digester are optionally sent to the centrifuge 316. Heated biosolids from the digesters are combined with sludge from the thickening tank 308 and the heated biosolids enhance the operation of the centrifuge 316. Additional excess heat from the biosolids dryer 304 is also fed via conduit 328 to the centrifuge 316 and the digester 302.

Still referring to FIG. 5, a suitable heating apparatus 332 is connected to the digester 302. For example, the heating apparatus 332 may receive heat or steam from the HRSG of FIG. 4. Alternatively or additionally, the heating apparatus 332 may be capable of producing heat on its own using an appropriate energy source. Once the biosolids in the biosolids dryer 304 have reached a desired level of dryness, the biosolids are typically sent via conduit 334 to the silo 306. The conduit 334 may comprise a variable speed outlet conveyor (not shown).

Turning now to FIGS. 6A and 6B, a further system 400 is shown, which is similar to the system shown in FIG. 2, except the system 400 omits the combined gas storage reservoir 236 of FIG. 2, and instead, synthesis gas and biogas are separately fed to one or more boilers 402. A synthesis gasifier 404 may be similar or identical to the gasifier 110 (FIG. 1) or the gasifier 206 (FIG. 2). Similar to other embodiments, the gasifier 404 is fed by a RDF source 406 and sends synthesis gas through a heat exchanger, such as HRSG 408. The HRSG 408 sends reduced temperature synthesis gas to gas cleaning equipment 410 and also sends high-pressure steam via conduit 412 to turbine 414 to generate energy. Clean synthesis gas leaves the gas cleaning equipment 410 and travels via conduit 416 to a synthesis gas intake 418 of the boiler 402. The boiler 402 may optionally include a steam accumulation tank 420. The steam output of the boiler 402 is preferably regulated to match the electrical consumption of the building 256 (see FIG. 4) and other onsite equipment (e.g. lights, pumps, etc.) that use electrical power. Therefore, the tank 420 may be helpful for the purpose of regulating the steam output so that a stored quantity of steam is available for peak electrical usage periods.

Biogas 422 is sent to biogas cleaning equipment 424 and, once cleaned, preferably travels to a biogas storage tank 426. The biogas is then sent to a biogas boiler intake 428. The boiler 402 also includes an ambient air intake 430. The biogas and synthesis gas may be combusted together in the boiler 402 using one burner, or alternatively the gases could be combusted with separate burners. Flue gas may exit the boiler 402 at a suitable port 432. An additional heat exchanger (not shown) is optionally added to the system 400 to capture heat from the flue gas. Low pressure steam may travel from the turbine 414 through a first pathway 434 to a hot water heat exchanger 436. The heat exchanger 436 preferably includes a process water inlet 438 and a condensate outlet 440. Hot water travels via conduit 442 from the heat exchanger 436 to a sludge processing pathway 444.

Low pressure steam from the turbine 414 may also follow a second pathway 446 from the turbine 414 to a divergence point 448. Such low pressure steam may then diverge into an HVAC pathway 450, that routes the steam to the plant building 256 (FIG. 6B) HVAC system, and/or a second pathway 452, which converges with the sludge processing pathway 444, as seen in FIG. 6B.

As best seen in FIG. 6B, steam travels along the pathway 444 to a biosolids dryer 446. A separation bin 448 is provided that screens out biosolids particles of non-conforming size using standard sieve equipment. The preferred size of the biosolids particles is preferably between about 1 mm and about 4 mm. Particles less than about 1 mm have a tendency to flow, much like a liquid, which may not be desired for some end user fertilizer equipment. Particles greater than about 4 mm may likewise be too large for some end user fertilizer equipment. The dried material is screened in the separation bin 448 to remove particles that are too large and too small. The production for the dryer 446 (or each dryer in multiple dryer embodiments) is preferably screened to a conventional fertilizer size of a using standard sieve having a mesh size of about #6 to about #18 or smaller as defined using the Tyler Equivalent standard. The rejected larger sized granules are typically crushed to a smaller size and combined with the undersized particles and then recycled as reflux to be part of the dryer feed. A reflux conduit 451 may extend from the separation bin 448 to route non-conforming biosolids back into the biosolids dryer 446.

The biosolids material is sent from the separation bin 448 by conveyor or other suitable means to a sizing and cooling apparatus 452. The screened granules are cooled in the cooling apparatus 452 to allow for the proper temperature prior to storage in a silo 454 before being sent to the market as fertilizer. The cooling apparatus 452 may employ an air system, which mixes cooling air with the dried hot granules. Effluent cooling water may be used in a direct Venturi contact system as known in the art. The cooling of the hot dried granules is accomplished by mixing cold air with the hot granules. The hot air is cooled in a direct Venturi water device (not shown) that reduces the heat content of the air that is recycled back to cool the granules. The water that is heated is sent to the sewer and new cold water is added to the device. From the cooling apparatus 452, the biosolids material is sent to the fertilizer silo 454 for storage.

Still referring to FIG. 6B, a thickening tank 456 and phosphorous treatment apparatus 458 are in communication with a centrifuge 460. The phosphorous treatment apparatus 458 may optionally include the chemical treatment apparatus 320 shown in FIG. 5. The phosphorous treatment apparatus 458 further includes a discharge 462 to a sewer (not shown).

Water vapor and organic vapor may also travel from the biosolids dryer 446 into a condenser 464. The vapors that are created from the dryer 446 have the dust removed by the use of a suitable dry cyclone separator (not shown), which is well known in the art that recycles the dust back to the drying process. The dust-free vapors are sent to the condenser 464 to be condensed by Venturi water scrubbing as known in the art, using plant effluent. The water mixture can be used to generate hot water, or further cooled with water to be discharged to the main drain of the plant. The non-condensable vapors are treated in a thermal oxidizer 466 to destroy the odors. It should be noted that thermal oxidizer 466 operates at a high temperature of about 1800° F. for about two seconds to incinerate vapors and is therefore expensive to operate. It is therefore preferable to minimize usage of the oxidizer 466 by condensing a maximum amount of vapor from the dryer 446 and using the condenser 464 so that condensate can be discharged to a main sewer drain of the plant rather than sent to the oxidizer 466.

The centrifuge 460 is also in communication with digested sludge from a digester 468. The digester 468 is in communication with the condenser 464, similar to the HRSG shown in FIG. 2. Organic vapors are sent from the condenser 464 to a thermal oxidizer odor control apparatus 470. The digester 468 may include a hot water inlet 472 in communication with the pathway 444, carrying steam from the turbine 414 that is shown in FIG. 6A. The digester 468 may further include a mixer 474.

It should be noted that additional components may be included as appropriate throughout the system. For example, heat exchangers could be positioned at other desired locations within any of the foregoing systems, such as any of the conduits illustrated. It should be further noted that in any of the illustrated embodiments, additional standby boilers (not shown) could be provided that are set up to run exclusively on fuel purchased offsite, such as natural gas. In addition, one or more boilers could be incorporated into any of the embodiments that run on biogas in combination with such natural gas. Furthermore, it should be evident that one or more boilers could be set up to run exclusively on synthesis gas or biogas. Such standby boilers could be advantageous during periods in which RDF fuel or biosolids fuel is less available, and these standby boilers could also be useful in instances when other boilers are shut down for maintenance.

### INDUSTRIAL APPLICABILITY

Numerous modifications will be apparent to those skilled in the art in view of the foregoing description. Accordingly, this description is to be construed as illustrative only and is presented for the purpose of enabling those skilled in the art to make and use what is herein disclosed and to teach the best mode of carrying out same. The exclusive rights to all modifications which come within the scope of this disclosure are reserved.

We claim:

1. An energy conserving wastewater treatment system, capable of being fueled by alternate fuel sources, the system comprising:
a synthesis gas generator that produces synthesis gas from a fuel;
an organic waste digester that produces biogas;
a combined synthesis gas and biogas storage reservoir in communication with both the synthesis gas generator and the organic waste digester; and
at least one boiler in communication with the combined synthesis gas and biogas storage reservoir.

2. The system of claim 1, wherein the fuel is refuse derived fuel.

3. The system of claim 1, wherein the organic waste digester produces biogas from anaerobic digestion of biosolids.

4. The system of claim 3, wherein the boiler is in communication with an electricity generating apparatus that is provided as a turbine.

5. The system of claim 4, wherein the turbine is in communication with a heat exchanger that transfers steam from the turbine to the organic waste digester.

6. The system of claim 1 further including synthesis gas cleaning equipment that cools the synthesis gas and removes contaminants from the synthesis gas, and further comprising a heat exchanger that transfers heat from the synthesis gas to another location in the system.

7. The system of claim 6, wherein the other location is the at least one boiler.

8. The system of claim 6, wherein the other location is a biosolids dryer.

9. The system of claim 6, wherein the synthesis gas cleaning equipment is located upstream from the combined synthesis gas and biogas storage reservoir.

10. The system of claim 1, wherein the boiler is in communication with the organic waste digester.

11. The system of claim 1, wherein the boiler is in communication with a building to transfer steam thereto for comfort heating or cooling.

12. The system of claim 1, further comprising a phosphorous enhancing subsystem.

13. The system of claim 12, wherein the subsystem comprises a centrifuge that is in communication with at least one of a thickening tank, the organic waste digester, and a biosolids dryer.

14. An energy conserving wastewater treatment system, capable of being fueled by alternate fuel sources, the system comprising:
a synthesis gas generator that produces synthesis gas from refuse derived fuel;
gas cleaning equipment that cleans the synthesis gas;
a first heat transfer apparatus that transfers heat from the synthesis gas and sends the heat to a sludge dryer;
an organic waste digester that produces biogas from anaerobic digestion of biosolids;
biogas cleaning equipment that cleans the biogas;
at least one boiler that receives at least one of the synthesis gas or the biogas or a combination thereof; and
an electricity generating apparatus in communication with the boiler.

15. The system of claim 14, wherein the first heat transfer apparatus is a heat recovery steam generator.

16. The system of claim 14, further comprising a combined synthesis gas and biogas reservoir in communication with both the synthesis gas generator and the organic waste digester.

17. The system of claim 14, wherein the electricity generating apparatus is in communication with the boiler and further comprises a heat exchanger that transfers water from the electricity generating apparatus to at least one of the organic waste digester, a dryer, the at least one boiler, a centrifuge, or a building.

18. The system of claim 14, further comprising a phosphorous enhancing subsystem.

19. The system of claim 18, wherein the subsystem comprises a centrifuge that is in communication with a thickening tank, the organic waste digester, and a biosolids dryer.

20. A method of conserving energy in a wastewater treatment plant, the method comprising the steps of:
producing synthesis gas from a fuel using a synthesis gas generator;
producing biogas from the anaerobic digestion of biosolids using an organic waste digester;
capturing heat from the synthesis gas production and sending the heat to a biosolids dryer;
providing at least one boiler for combusting at least one of either the synthesis gas or biogas; and
sending steam produced by the boiler to both a turbine and to the organic waste digester.
